(19) United States
(12) Patent Application Publication
(10) Pub. No.: US 2025/0037368 A1
(43) Pub. Date: Jan. 30, 2025

(54) UNIVERSAL COLOR LANGUAGE MODEL TO MAP AND INDEX DATA POINTS FOR MACHINE LEARNING AND ARTIFICIAL INTELLIGENCE

(71) Applicant: ZENCOLOR GLOBAL, LLC, MIAMI, FL (US)

(72) Inventor: DANN GERSHON, MIAMI, FL (US)

(21) Appl. No.: 18/784,864

(22) Filed: Jul. 25, 2024

Related U.S. Application Data
(60) Provisional application No. 63/528,899, filed on Jul. 25, 2023.

(51) Int. Cl. G06T 17/00; G06Q 30/0601; G06T 3/067

(52) U.S. Cl. CPC G06T 17/00; G06Q 30/0641; G06T 3/067

(57) ABSTRACT

A computer-implemented method for homogenizing a RGB digital color cube into a smaller and usable subset. Fixed coordinates of the RGB digital color space are merged into a color cube, mapped to distinct hue corner sides and layers that get progressively smaller until sides of the color cube converge in a center point of a three-dimensional nesting cube model to form a merged three-dimensional color nesting cube comprising a plurality of individual nesting cubes. Duplicate colors in the RGB digital color space that are not distinguishable to a human eye are consolidated to obtain a smaller and usable digital color space. The smaller and usable digital color space are organized into equidistant color buckets to provide an orientation throughout the merged three-dimensional color nesting cube. Each cube of the merged three-dimensional nesting cube represents a unique color mapping code of a universal digital data-mapping color language model.

### RELATED APPLICATION

This application claims benefit of Provisional Application No. 63/528,899 filed Jul. 25, 2023, which is incorporated herein by reference in its entirety.

### FIELD OF INVENTION

The claimed invention relates to a universal color language model, more particularly, a method and system for mapping and indexing product data points for machine learning and artificial intelligence from digital and non-digital color mediums using the universal color language model.

### BACKGROUND OF THE INVENTION

At times, a user will want to search for a product by color even though it is an attribute that cannot be described adequately using words or numbers that represent digital color coordinates that are not distinguishable to the human eye. For example, other than using rudimentary color names, such as “red” and “blue,” searching for products of a particular shade using color as a parameter is extremely difficult, even when the color is relatively popular and intuitively should be easy to locate. For example, there are numerous colors which would fit the simple “red” or “blue” description and searching using the textual word “red” is not likely to bring up the specific red or the specific product of interest. Also, searches based on a particular type of color by name, such as “rose red” or “ocean blue,” are unlikely to turn up the color of interest, as there may be a number of different colors, each with a different name or with multiple names varying by the naming convention used. Similarly, searching for a pattern made of colors, such as “blue and red stripes” is unlikely to turn up the desired pattern of particular colors.

Many of the drawbacks involving color-based searching stem from the nature of internet searching, which has historically been text-based, thus requiring a user to enter text into a search engine to describe the information sought. With regard to color, textual color names are typically tagged or embedded beneath an image of a product or associated webpage as metadata, making it virtually impossible to obtain reliable and complete search results when specific color shades are sought. More specifically, because many search systems that implement searching based on a color (or a pattern) are operable only as text searching, a system may allow a user to select a color by name or even “click” on the color (in the form of a color swatch) and then search for the selected color. However, in these instances, the system typically converts the inputted search parameter to a text-string associated with or representing a particular color. For example, a search system may search based on clicking red swatch on a webpage but converts the click to a search for “red” as text, but not as an actual color. In such a system, the name of the color “red” is “tagged” to an image by way of a text string and the search is based on matching the input “red” to the text string “red” on the tag, and not to the color. From a consumer's perspective, such a system is insufficient to reliably capture all relevant products that are currently available in the particular shade of red that are being sought. From a Merchant perspective, such a system does not allow for dynamic analysis or codification of color that is a crucial but missing data set in understanding consumer preferences.

Even color systems that offer naming conventions suffer from underlying drawbacks in their inconsistent application by Merchant users and their vendors. For example, a wholesale buyer for a retailer may decide to order a line of products from a vendor in a color that is identified as “cobalt blue.” A second wholesale buyer at the same retailer may order another line of products from a second vendor in a color that the second buyer also identifies “cobalt blue,” having the intention that the colors be precisely the same so that a purchaser of product from the first line will be more inclined to purchase the second line of product as a matching set. Indeed, the variation in color between two products that purportedly have the ‘same color’ can be remarkable when the products are placed side by side. The lack of consistency among vendors and suppliers, even when the same color names are utilized, is often not appreciated until after the products arrive, at which time it is too late to ameliorate the situation.

Direct searching based on a particular color or a swatch has not been effectively accomplished with text-based systems or search systems that lack a universal color system. For example, if a user is in possession of one article of clothing and wishes to purchase a matching item, existing tools leave the user with the burden of determining the color of the clothing and what a matching color might be. Thus, the user is left to matching based on what “appears” to match (subject to variations in color on a screen).

Current systems further lack the ability to aggregate a user's preferred and/or customized colors onto a unified area or palette for purposes of identifying and searching for products. Individuals typically have preferred colors. and it would be beneficial to have that group of preferred colors collected and readily available to that user in a single palette. Also, use of the palette for forming color combinations and to perform searches based on a primary color and a secondary color (and a pattern) are lacking in the prior art. To that end, it would be beneficial to have that group of preferred colors identified, collected and readily available to that user in a single palette for effective color-based searching. Since these searches are presently unavailable, the data associated with these searches is also unavailable to be used for any data analytics, real-time or otherwise. Such data analytics would be useful to merchants and/or manufacturers for both marketing and operations purposes. These analytics could relate to user preferences for colors and patterns by analyzing user browsing and purchasing behavior, and with associated user data, such as demographic data. Such information can be made available across a variety of user variables (e.g., gender, age, geography, etc.).

In addition to the deficiencies and drawbacks of current systems for consumers, there are many related deficiencies for merchants, retailers, wholesalers and/or manufacturers as well. To start, the captured data can be used for targeted or micro-targeted advertising based on, for example, user preferences, preferences of affinity group members, or user purchase/browsing history.

While current inventory management systems (IMS) include inventory reporting and analysis, and current supply chain management (SCM) systems include production reporting, the merchants, retailers, wholesalers and/or manufacturers currently lack real-time consumer related data to properly forecast and respond to color-trending data. Because of its ability to identify histories of user browsing and purchases in combination with user demographics, the claim invention allows Merchants to forecast color trends in real time and determine, by product and demographics, which colors will be most successful, and plan supply chain and inventory management accordingly. Retailers and manufacturers currently rely on focus groups, which can include as many as 30,000 people in the relevant demographics and geo-locations to sample and obtain user color information. Such an effort is both time-consuming and costly. Because gathering and analyzing of data from the group can take up to eighteen months, once a sampling is complete, the data may no longer be relevant. The SCM must be adjusted in real-time to create the appropriate adjustments during the manufacturing process. More and more retailers and wholesalers are working with “just in time” inventory, shifting the onus from the retailer to the vendor or the factory. Adjustments in the SCM are the only solution to the inventory problems. Thus, by capturing user preferences based off of a purchase history, browsing history, word association, and color selections, all captured in real time, a relevant collection of data may be obtained and used by Merchants to enhance the consumer experience and streamline operations.

Unfortunately machines, unlike humans, cannot “see” or describe color. To do so requires the creation of a mathematically based and objective universal color data mapping language model. Such a language model would be able index the product data input from all other color mediums, both digital and non-digital.

### OBJECT AND SUMMARY OF THE INVENTION

Therefore, it is an object of the claimed invention to provide a universal color data mapping language model which allows indexing of the product data points from all digital and non-digital color mediums for machine learning and Artificial Intelligence in ways that mimic, and in many ways exceed, a human being.

Various other objects, advantages and features of the present invention will become readily apparent from the ensuing detailed description, and the novel features will be particularly pointed out in the appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The above-described and other advantages and features of the present disclosure will be appreciated and understood by those skilled in the art from the following detailed description and drawings of which:

FIG. 1 is a flow diagram showing the need and difficulty of converting non-digital color data to RGB (red-green-blue);

FIG. 2 is a flow diagram showing the subjective and unreliability of describing colors;

FIG. 3 is a diagram of sRGB color cube to apply color to websites in accordance with an exemplary embodiment of the invention;

FIG. 4 illustrates variations in assigning color attributes for the RGB color cube from human and machine perspective;

FIG. 5 illustrates a three-dimensional view of the sRGB coordinate model;

FIG. 6 illustrates a two-dimensional view of the sRGB coordinate model;

FIG. 7 illustrates a center cube view of sRGB coordinate model;

FIG. 8 illustrates replacement of a coordinate-based model with a cube-based model to eliminate the gaps in the sRGB color cube in accordance with an exemplary embodiment of the invention;

FIG. 9 illustrates the cubes that make up a nesting cube model in accordance with an exemplary embodiment of the invention to provide a format to properly align the sRGB coordinates into midpoints and a defined center;

FIG. 10 illustrates the center point of the nesting cube;

FIG. 11 illustrates the coordinates in the sRGB color cube that are merged into a new nesting cube format to properly align the sRGB coordinate model in accordance with an exemplary embodiment of the invention;

FIG. 12 illustrates the sRGB coordinates retaining their fixed mapping positions as they are merged into the new nesting cube model in accordance with an exemplary embodiment of the invention;

FIG. 13 illustrates the sRGB coordinates housed within the individual nesting cubes, retaining their orientation to the eight defined corners of both the sRGB cube and the nesting cube models in accordance with an exemplary embodiment of the invention

FIG. 14 illustrates merging of all 16,777,216 coordinates that comprise the 24-Bit sRGB color cube into the new nesting cube model in accordance with an exemplary embodiment of the invention;

FIG. 15 illustrates the interview of the nesting cube model, which connects the six sides of the cube at every layer in accordance with an exemplary embodiment of the invention;

FIG. 16 illustrates the connected layers of the nesting cube approaching the center, layer by layer in accordance with an exemplary embodiment of the invention;

FIG. 17 illustrates the nesting cube model comprising six pyramid-like formations that share a common center in accordance with an exemplary embodiment of the invention;

FIG. 18 is sectional view of the pyramid formation in accordance with an exemplary embodiment of the invention;

FIG. 19 illustrates the Hue Corners (red, yellow, green, cyan, blue, and magenta) defining the sides of the nesting cube in accordance with an exemplary embodiment of the invention;

FIG. 20 illustrates the layers of the nesting cube converging at the center point (X-Axis) in accordance with an exemplary embodiment of the invention;

FIG. 21 illustrates machine views of the color code which is a perfectly balanced and equidistant Cartesian mapping system in accordance with an exemplary embodiment of the invention;

FIG. 22 illustrate a machine view of the nesting cube, sRGB color visualization and a human view of the nesting cube in accordance with an exemplary embodiment of the invention;

FIG. 23 illustrates a human view of the color code shown FIG. 21 by adding the color attribute to the nesting cube format in accordance with an exemplary embodiment of the invention;

FIG. 24 illustrates the sRGB cube mapped to 8-Bit channels to aligned to the nesting cube format in accordance with an exemplary embodiment of the invention;

FIG. 25 illustrates a color picker which is a three-dimensional nesting cube model flattened to a two-dimension model with navigation in accordance with an exemplary embodiment of the invention;

FIG. 26 is a flowchart of a universal data mapping color language model used to collect and index both digital and non-digital data points for machine learning and Artificial Intelligence in accordance with an exemplary embodiment of the invention;

FIG. 27 is a flowchart of a universal data mapping color language model showing its application to a wide variety of useful applications across all aspects of the product ecosystem that benefits both retailers and consumers in accordance with an exemplary embodiment of the invention;

FIG. 28 is a block diagram of the system in accordance with an exemplary embodiment of the claimed invention; and

FIG. 29 is a block diagram of the server in accordance with an exemplary embodiment of the claimed invention.

### DETAILED DESCRIPTION OF THE EMBODIMENTS

The color-based data points cannot be indexed or machine learning and artificial intelligence with a universal color language model.

All people see and describe color differently, using a myriad of different words to describe the exact same color. These descriptions are subjective, random, and fail to convey meaning. Further, the multitude of diverse digital and non-digital mediums provide no standardized language to effectively and objectively define vast amounts of structured and unstructured color data that are captured every single day. This makes it impossible to properly index those data points for machine learning and Artificial Intelligence.

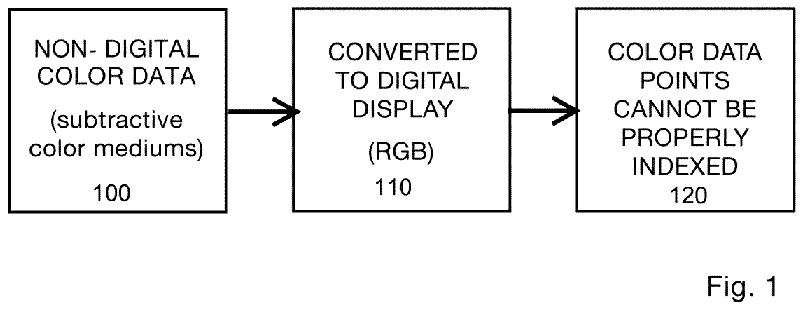

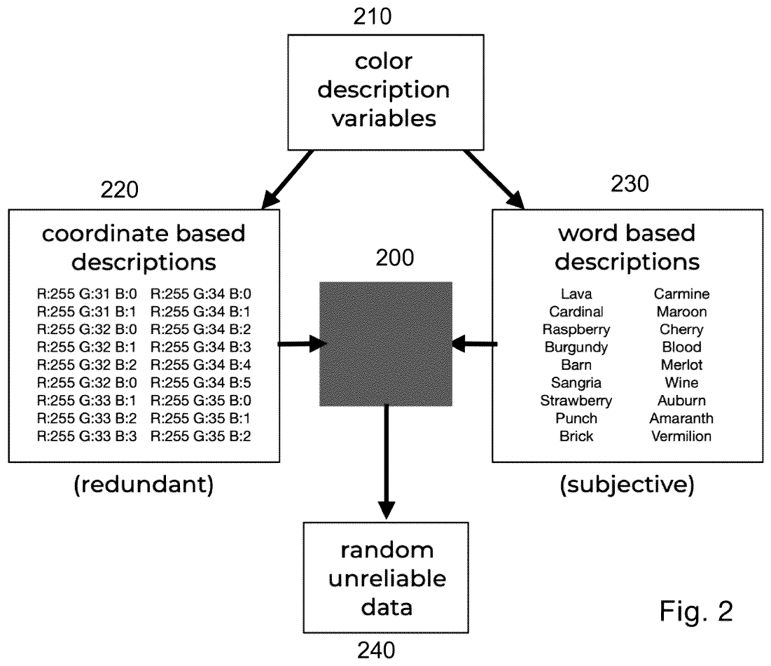

Turning now to FIG. 1, there is illustrated a flow diagram showing the need and difficulty of converting non-digital color data to RGB (red-green-blue). Non-digital color mediums, step 100, are dependent on physical substrates that must be converted to RGB (red-green-blue), step 110, to display on a device, e.g., a monitor, smartphone and the like. As such, this provides the digital input by which all color data can be collected. The millions of RGB coordinates, however, are no better than using meaningless words to describe a color. The description is random and completely subjective. To that point, there are far too many redundancies in these color coordinates to create the basis for a usable color language model. While the color data can be captured with a coordinate system, the redundancies in the coordinates make it impossible to properly decipher and index the data points for machine learning and Artificial Intelligence, step 120. As exemplary illustrated in FIGS. 1 and 2, the coordinate-based descriptions 220. The claimed invention solves this problem by generating al color data mapping language model that can translate and index all digital and non-digital color mediums into a universal and understandable standard.

### The RGB Color Cube

While the RGB color space is infinite, the sRGB color cube or coordinate model 300 contains precisely 16,777,216 mapped coordinates. All coordinates are arranged in a fixed position within the eight corners of the color cube. There is no version of the RGB color space that contains less coordinates than the sRGB color picker. It should be noted that there are various interpretations of sRGB, but all are based on a 24-Bit system with 8-Bit channels, one for each value of red, green, and blue. The various versions provide slightly different color attributes, but these attributes are too similar to one another to be differentiated by the human eye. Based on this, the color data becomes subjective. Further, utilizing the same 24-Bit mapping system to describe the color attribute is not meaningful to a machine. The machine cannot separate one version from another as they are all based on exactly the same coordinate mapping system. To some degree, this presents the same problem as using different names to describe exactly the same color. That makes it difficult, if not impossible, to properly define the data.

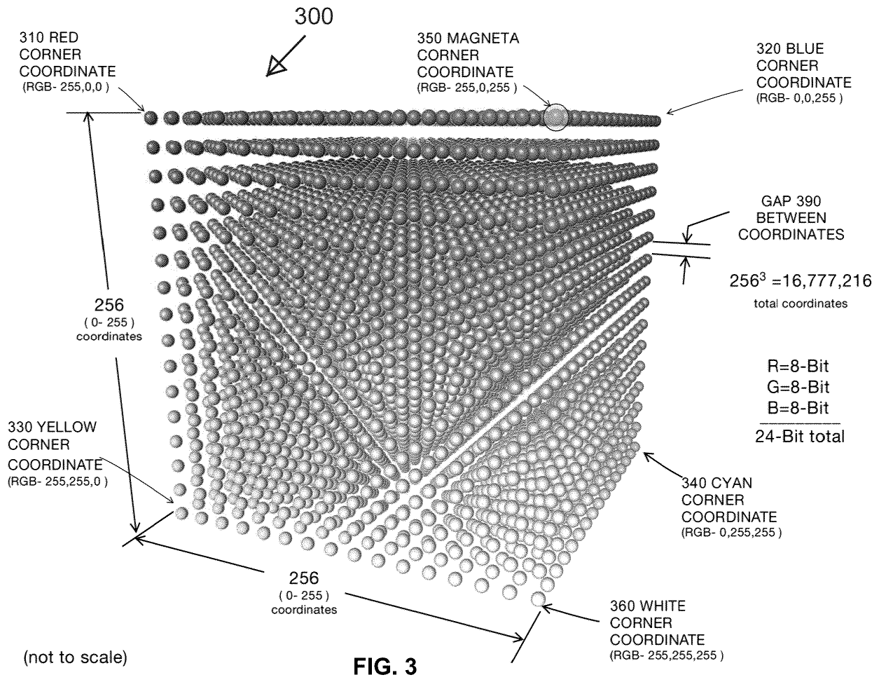

Turning now to FIG. 3, the three-dimensional sRGB color cube 300 has distinct eight corners (Red 310, Green, Blue 320, Yellow 330, Cyan 340, Magenta 350, Black, and White 360). The outside perimeter of the three-dimensional sRGB color cube 300 is comprised of 256 coordinates, numbered from 0 to 255 per channel. The coordinates are measured from corner to corner on the outside layer of the cube, which creates 16,777,216 (256×256×256) unique coordinates in total. While the sRGB color model representation may appear to be solid and cohesive, there are actually “gaps” 390 between all of the coordinates that occupy the three-dimensional cube.

RGB is the native language by which all color is displayed on a digital substrate. It is device dependent. All non-digital color mediums must be converted to RGB in order to display color on a device. As non-digital mediums are subtractive and digital mediums are additive, a conversion from non-digital to digital is, at best, an approximation. The need for a digital color medium, however, is relatively new. sRGB is the world's default color space, developed to display and code digital content for the web. The sRGB color cube was created in 1996 as a means to apply color to websites. The three-dimensional color cube was converted to a two-dimensional color picker that made it easier for both coders and designers to search for and locate a specific sRGB color coordinate. As digital technology improved, however, there was a need for color to display beyond an 8-Bit channel. The sRGB color picker, based on the 8-Bit RGB channels, remained in computer aided design (CAD) and drawing programs as a means for designers and coders to select and communicate digital color palettes. It is still in use today.

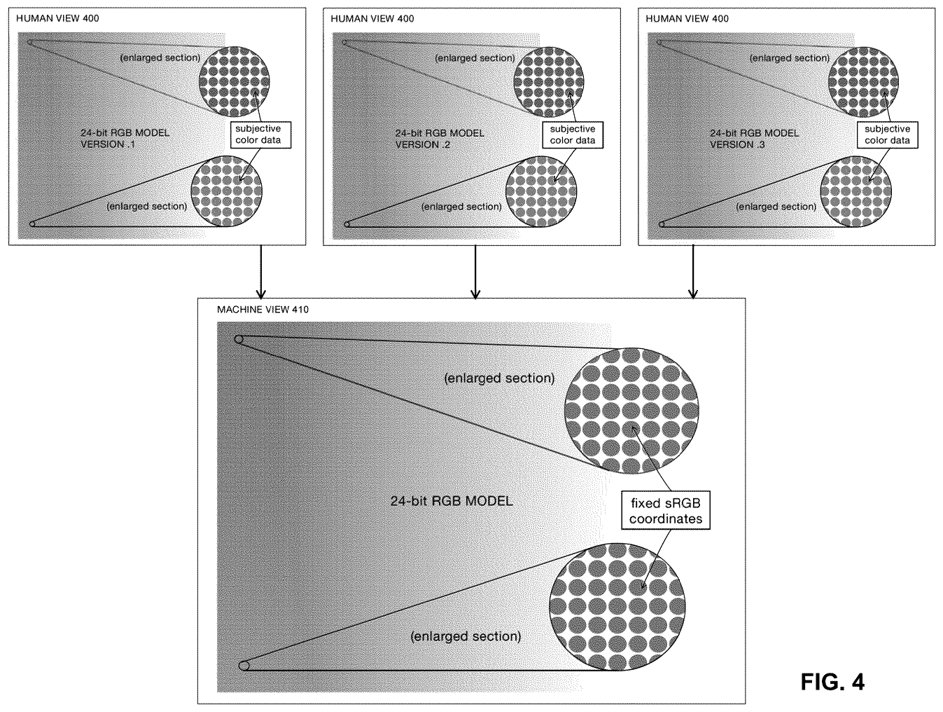

The sRGB color space consists of millions of redundant coordinates that are indistinguishable to the human eye. Variations on methods to assign color attributes for the RGB color cube adds to the problem of human visualization as there is no variation as to the number of fixed coordinates (16,777,216) or the mapping system. As exemplary shown in FIG. 4, the human eye cannot distinguish the difference in color (human view 400), but a machine cannot see it at all (machine view 410). As a data language model, it is akin to speaking gibberish. From a data standpoint, the conversion of a non-digital medium to sRGB is a random approximation. One hundred designers could use one hundred different sRGB coordinates to describe the same exact color. This makes it as random and subjective as using a word to describe a color. The sRGB coordinate system was intended to provide a means to display color palettes that pertain to design and coding content, as opposed to a precise analytics system. When used for its intended purpose, the redundancies in the language do not matter. These redundancies, however, make it impossible to index color data for machine learning and Artificial Intelligence. This requires a way to remove the redundancies from the sRGB color model without removing a single coordinate.

### RGB Coordinate Model

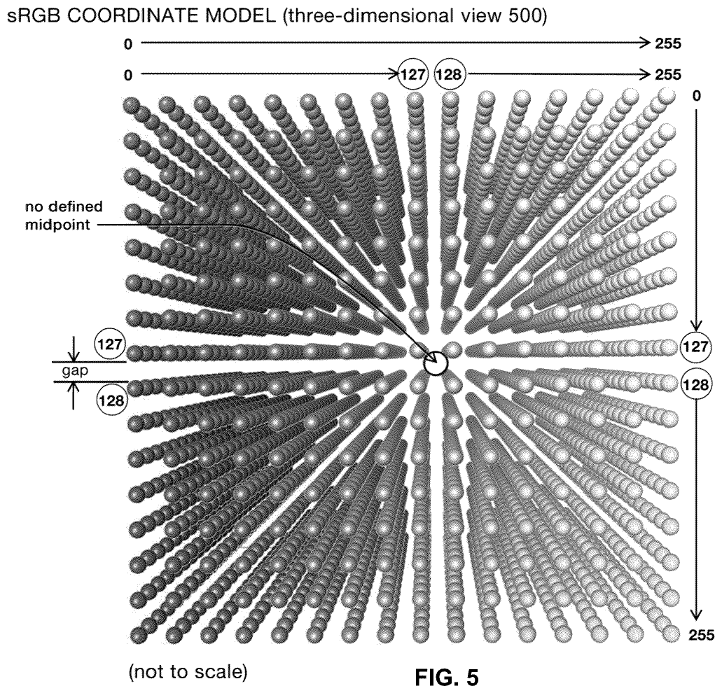

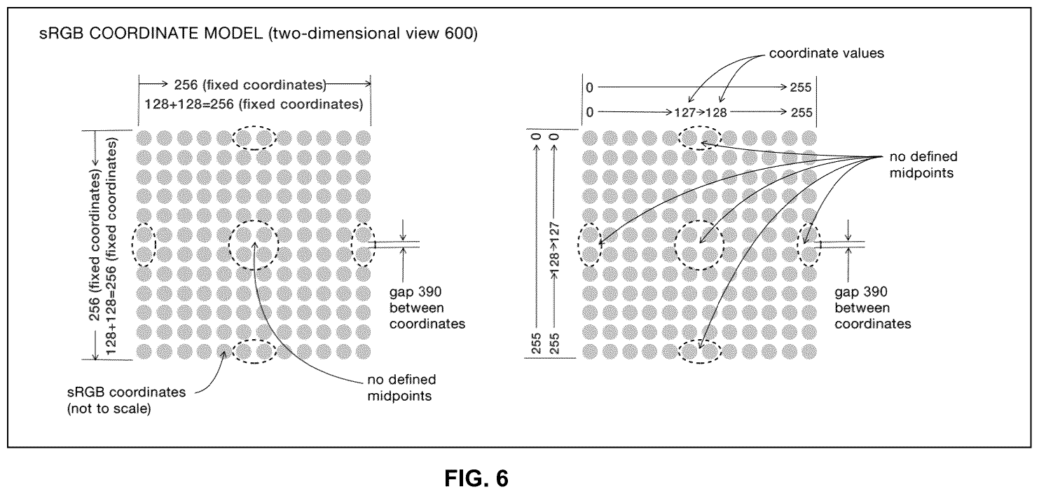

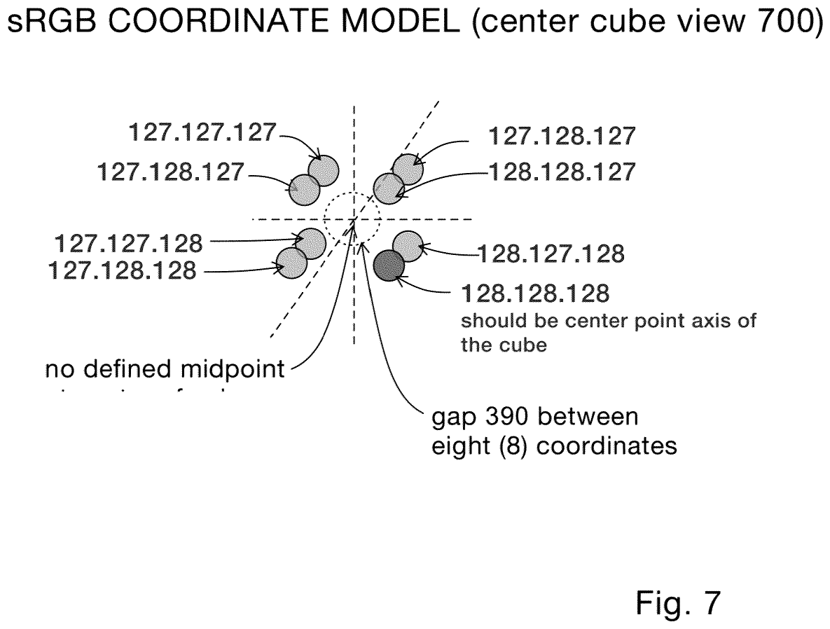

FIGS. 5, 6 and 7 provide a color cube or a three-dimensional view 500, two-dimensional view 600 and center cube view 700 of the sRGB coordinate model, respectfully. There are natural spaces or “gaps” 390 between all of the fixed sRGB coordinates inside the color cube. The full length, from corner to corner, of the sRGB color cube 300 contains a total of 256 coordinates that are mapped from 0-255 per RGB channel. Half the distance of each side of the outer layer of the cube (x/2=y) is mapped from 0-127 and 128-255. It would seem logical to simply divide the length in half (256/2=128) to determine the midpoint. That, however, does not work based on the mapping of the coordinates. The coordinates mapped to values of 127 and 128 will reside on either side of the gap in the middle. In this sense, the appearance of a midpoint is an illusion. This occurs throughout the sRGB color cube 300. For example, drawing lines that connect the eight opposite corners (256/2=128) of the cube should intersect to create a center point axis. One coordinate (R: 128 G: 128 B: 128) should be located at the drop-dead center of the sRGB color cube 300. It does not, the mapping for the sRGB color cube 300, however, creates a gap 390 where the center of the sRGB color cube 300 should be located. In fact, it is only one of eight coordinates that surround the gap 390 in the center of the sRGB color cube 300. This lack of midpoints is consistent throughout the three-dimensional sRGB color cube 300.

Again, it is important to note that all of the sRGB coordinates that reside in the color cube are “fixed” in position and orientation, which is the means by which the color space can be mapped, and the coordinates located. As such, the lack of midpoints and a defined center point axis are not important in regard to the purpose for which it is designed. The sRGB color picker has no need for defined midpoints to locate and identify a coordinate color value. It was designed to be a “digital crayon” to apply color to websites and desktop publishing.

The redundancy that exists between the millions of coordinates, just like the lack of midpoints, is not important to the sRGB color model. The coordinates were not meant to be a color mapping language. The sRGB color model was not designed to index color data for machine learning and Artificial Intelligence. The claimed invention is predicated on the desirability of creating a new language model, specifically designed for data mapping and deep machine learning.

Replace Coordinates with Nesting Cubes

Adding a coordinate to the sRGB color space to create a midpoint is not possible. That would produce more coordinates than the sRGB space actually contains.
RGB COLOR CUBE:
256 (0-255), corner to corner
256×256×256=16,777,216 coordinates
ADDITIONAL COORDINATE:
256+1=257 (0-256), corner to corner
257×257×257=16,974,593 coordinates

The “gap” 390 that naturally occurs between the coordinates cannot be eliminated. The fixed position of the coordinates makes it impossible to create midpoints in the sRGB color model 300. As discussed herein, the halfway point between 256 coordinates is 128 (256/2). Due to the gap 390 between the fixed position of the coordinates, however, it is mathematically impossible to create a midpoint. The midpoint lies within the gap between the two fixed coordinates:
0-127 (128 coordinates)|128 (1 coordinate)|129-255 (127 coordinates).

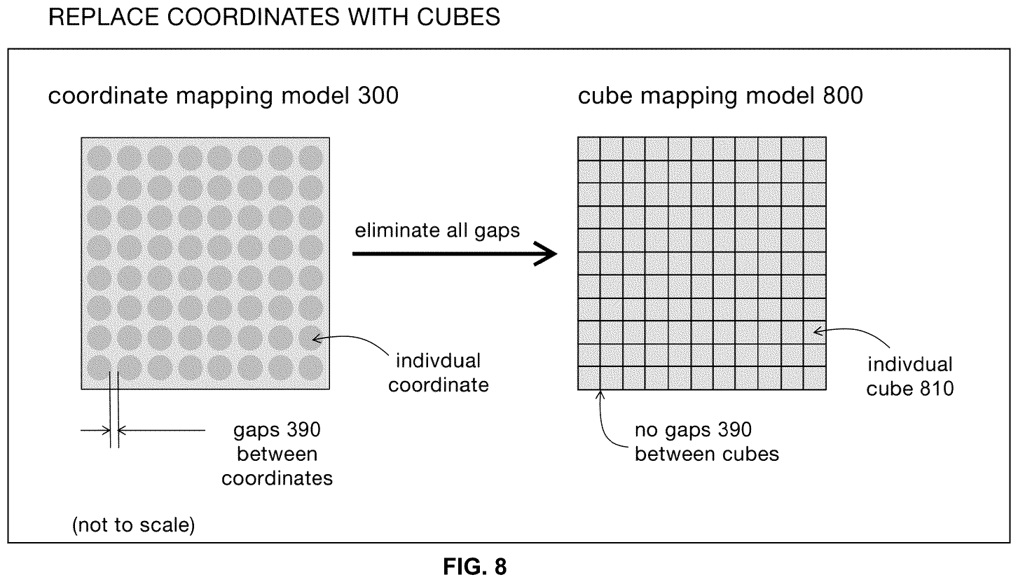

In accordance with an exemplary embodiment of the claimed invention, this problem is resolved by eliminating the gaps and creating midpoints. The claimed invention replaces the sRGB coordinate system 300 with a non-coordinate system or a cube-based model 800, which eliminates the gaps in the sRGB color cube 300. In accordance with an embodiment of the claimed invention, as shown in FIG. 8, individually mapped cubes 810 are utilized, which are fixed in position like the coordinates. Each individual cube 810 represents a microcosm of the whole color cube 800, and when properly aligned, provides a means by which to merge the sRGB coordinates that reside in the same space within the new nesting cube model 800. Merging the two models removes the redundancies in the sRGB color model 300 without removing a single coordinate.

Unlike coordinates, and in accordance with an embodiment of the claimed invention, the individual cubes 810 abut one another and there are no gaps 390 between the cubes 810. This advantageously provides another part of the solution. By eliminating the gaps, the claimed invention can create true midpoints throughout the nesting cube model 800.

While colorists regard RGB as a means to display color on a device, they ignore that sRGB provides a unique opportunity to capture large steams of structured and unstructured color and product data. To exploit this opportunity, however, requires a new color language model. In accordance with an exemplary embodiment of the claimed invention, the new color language model merges the color coordinates into color cubes 810. This advantageously removes the redundancies in the 16,777,216 sRGB coordinates without removing a single coordinate. To enhance the usability of the new color language model, in accordance with an exemplary embodiment of the claimed invention, the nesting cube model provides a data mapping color language code that is intuitive and simple to learn.

### The Zencolor Cross Formation (+1)

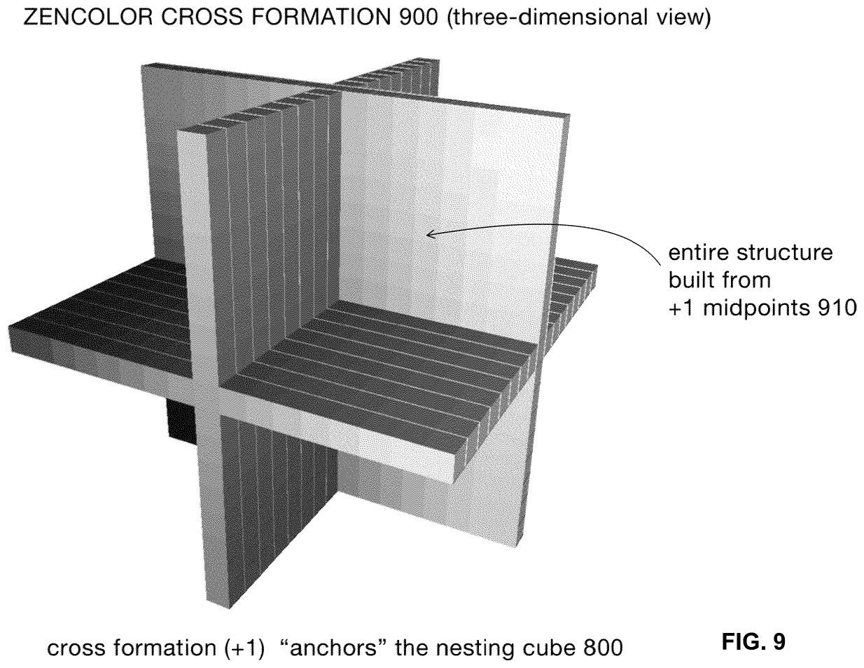

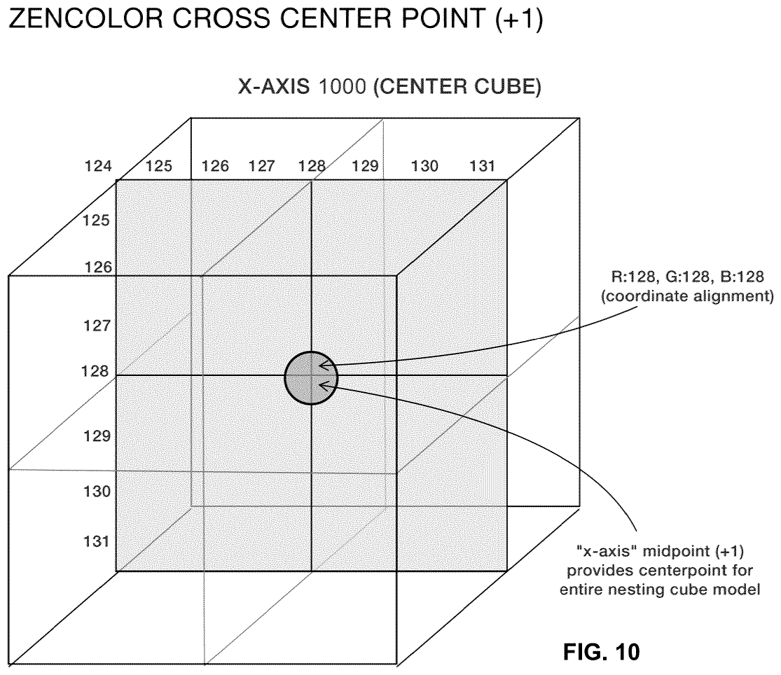

In accordance with an exemplary embodiment of the claimed invention, as shown in FIGS. 9 and 10, the coordinate system is replaced with individual cubes 810 that abut one another. Unlike the coordinates, in the claimed invention, there are no gaps 390 between the individual cubes 810. Whereas adding a coordinate (+1) to the sRGB color space 300 in order to create midpoints in the model is not possible, but creating such midpoints 910 through the use of an individually mapped cube format presents no problem. To accomplish this goal, the claimed invention applies a formula based on “y+1+y” as a format. This format creates midpoints 910 throughout the claimed cube-based model 800. In accordance with an exemplary embodiment of the claimed invention, these mapped midpoints 910 (+1) go from the outside of the three-dimensional cube 800 to the center of the cube (X-axis 1000) to form the “zenColor Cross.” The zenColor cross formation 900 of the claimed invention intersects at the middle of all six sides of the cube, extending from the outer layer to the center point or X-axis 1000. This center point or X-axis 1000 anchors the claimed nesting cube 800. The claimed zenColor cross formation 900 does not exist in the sRGB color cube model 300. The zenColor cross formation 900 feature is unique to the new nesting cube model 800 of the claimed invention.

### Align the Models

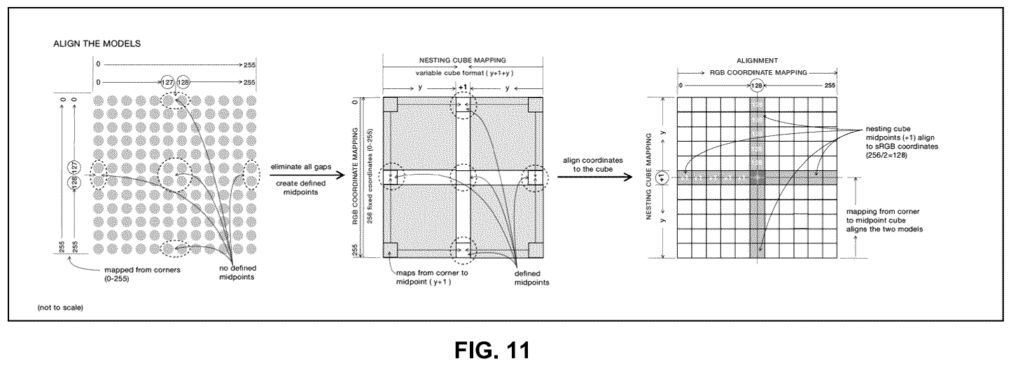

In accordance with an exemplary embodiment of the claimed invention, as shown in FIG. 11, the fixed positions of the sRGB color coordinates are aligned to the individual cubes 810 that make up the nesting cube model 800. The coordinates from sRGB cube are now properly aligned to create mathematically correct midpoints 910 throughout the claimed nesting cube structure 800. The creation of midpoints 910 in the claimed nesting cube model 800 provides a means by which to achieve this alignment. Whereas it is not possible to position the middle of the sRGB color cube 300 at the coordinate value of 128 (256/2), with the claimed invention, it is possible to align the cube in the middle of the nesting cube model format (y+1+y). The cube (+1) located in the center of the claimed nesting cube model 800 is a fixed position, regardless of the nesting cube format. The claimed invention provides a means by which to align the fixed sRGB coordinates to the fixed nesting cubes. In accordance with an exemplary embodiment of the claimed invention, the sRGB coordinate value of 128 is mapped to align with the exact center of the +1 cube. The other coordinates are mapped from the corners of nesting cube to the center midpoint of the +1 cube. This aligns the coordinates to the cube model, creating defined cube midpoints in the process.
CORNER→(+1) MIDPOINT←CORNER

For example, the sRGB coordinate (R: 128 G: 128 B: 128) that fell into the gap 390 between coordinates in the sRGB color space 300 now defines the precise center point of the individual cube 810. This is referred to as the “X-axis” 1000 in the new “nesting” cube model 800 in accordance with an exemplary embodiment of the claimed invention. Whereas this sRGB coordinate (R: 128 G: 128 B: 128) is not a center point in the sRGB color model 300, it is now at the drop-dead center of the new nesting cube model 800 of the claimed invention.

### Merge the Models

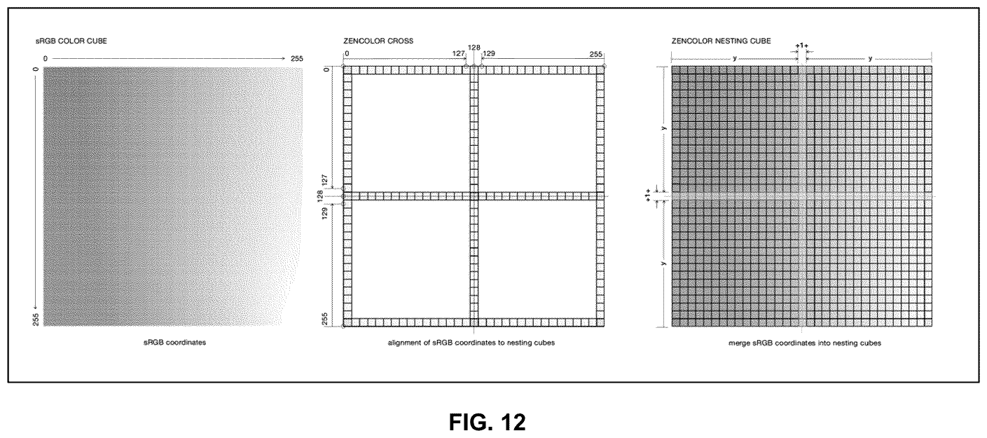

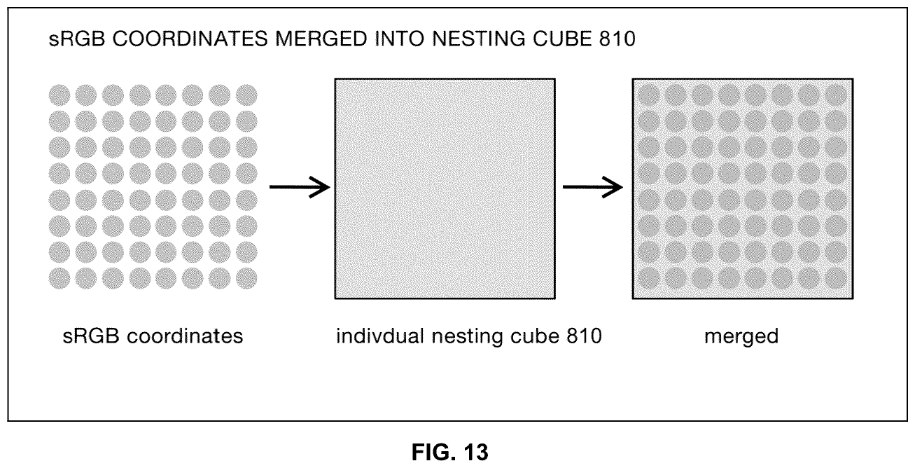

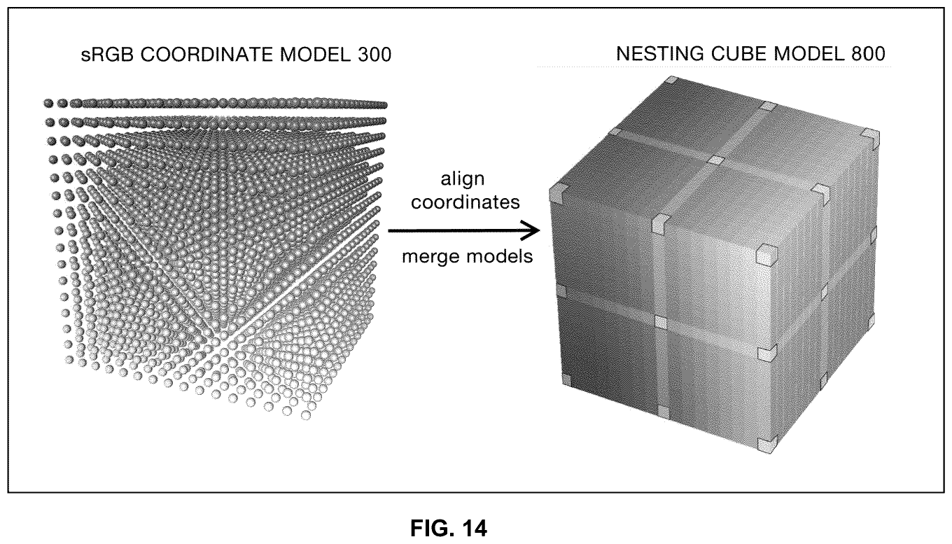

Once the two models are aligned, in accordance with an exemplary embodiment of the claimed invention, as shown in FIGS. 12-14, they are merged into a “bucket.” That is, the coordinates of the sRGB color cube are merged into the individual cubes 810 of the claimed nesting color cube 800, that already reside in the same fixed position, to provide a natural symmetry. This is possible because, while the two cubes are the same size, they are not mapped in the same way. The sRGB color cube 300 is mapped with coordinates, whereas the claimed nesting color cube model 800 is formatted by cubes 810 that are designed to hold the coordinates. In accordance with an exemplary embodiment of the claimed invention, the gaps 390 in the sRGB color cube 300 have been replaced with defined midpoints 910 in the claimed nesting color cube 800 (as noted herein, the zenColor Cross formation 900). Think of the two cubes as identical buildings that are impossible to tell apart when viewed from the outside. The 24-bit sRGB color cube or the sRGB color model 300 houses 16,777,216 coordinates that reside in fixed positions inside the cube-shaped building. The claimed nesting color cube model 800 contains cube-shaped apartments 810, the size of which is determined based on the format. When the two cubes are merged, in accordance with an exemplary embodiment of the claimed invention, the fixed coordinates (now aligned) are assigned to a cube 810 in the same fixed position and orientation. The midpoints 910 are now aligned to the individual cubes 810 in the claimed nesting color cube format 800. In the claimed invention, this alignment provides a means by which to “bucket” the sRGB coordinates into the individual cubes 810 without removing a single coordinate. All that remains is to assign “apartment numbers” by which to identify the cubes and apply a “paint job” that best represents the color attribute from the aligned sRGB residents.

### The Zencolor Nesting Cube Model

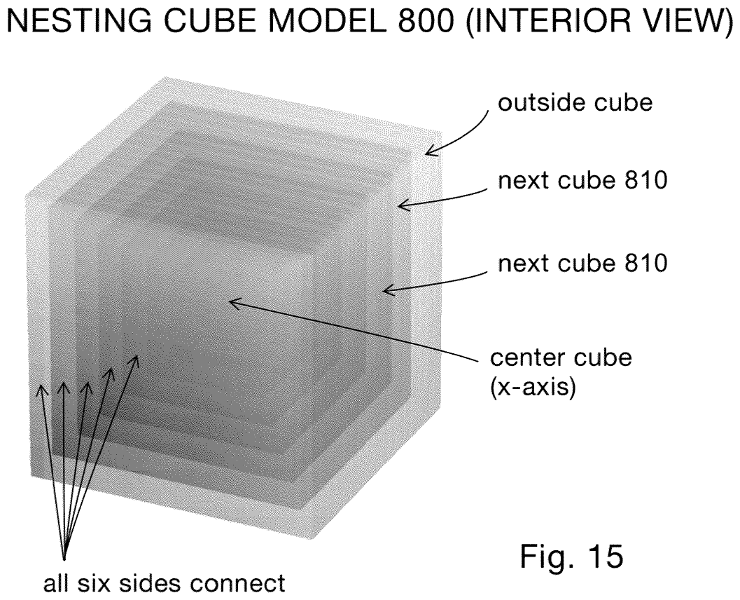

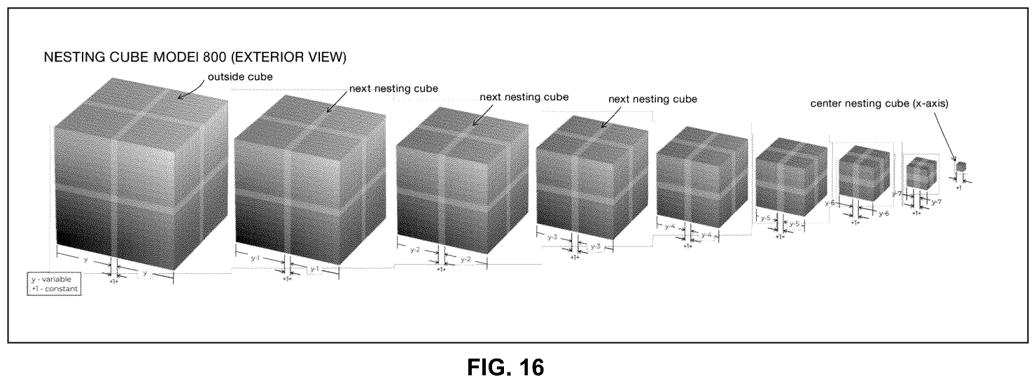

Turning now to FIGS. 15 and 16, the Cross formation (+1) or the zenColor Cross formation 900 (+1) is part of the format (y+1+y) that provides the midpoints 910 for the claimed nesting model 800, also known as the zenColor Nesting Cube model 800. In accordance with an exemplary embodiment of the claimed invention, all six (6) sides of the claimed “nesting” cube model 800 comprise a designation code for the hue (Red, Yellow, Green, Cyan, Blue, Magenta) that is positioned by the cube in the upper left-hand corner of the side. This remains constant from side to side and layer to layer. The black and white corners are considered grayscale and not a hue. The six sides of each layer connect to one another, layer by layer, to form a “nesting” cube 810. Much like a Russian nesting doll, the grid of each layer becomes progressively smaller, from the outside of the claimed nesting cube 800 until finally reaching the center of the cube 810 defined by the center point (X-axis) 1000. That is, the connected layers of the claimed nesting cube 800 approach the center, layer by layer. Peeling away the outer layers reveals that, while the cubes 810 in the claimed nesting cube format 800 remain the same size, the layers have less per side and become progressively smaller. In the claimed invention, the coded color cube that designates the shared center point (X-axis) 1000 is the last doll, so to speak. In accordance with an exemplary embodiment of the claimed invention, the individual color cubes are equidistantly mapped into grids, plotted by Longitude and Latitude, and represented by a six-digit code that represents the Cartesian mapping language.

### Pyramid Formation

The claimed nesting cube model, like the sRGB color cube 300, has eight defined corners. Unlike the sRGB color cube model 300, however, the claimed nesting cube model 800 is connected and anchored to a defined midpoint 910 called the X-Axis. Instead of eight equal quadrants, in accordance with an exemplary embodiment of the claimed invention, the nesting cube model 800 comprises six pyramid-like formations 1700 that share a common center.

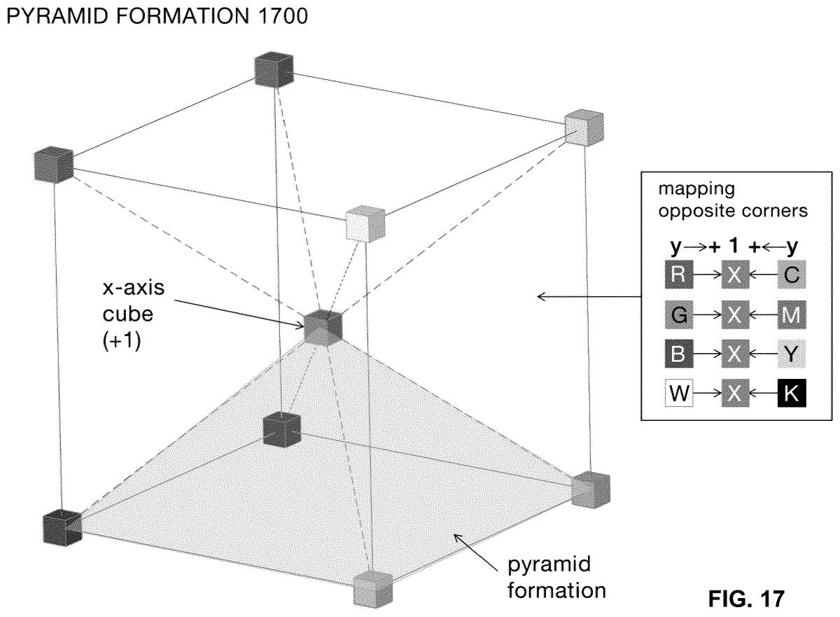

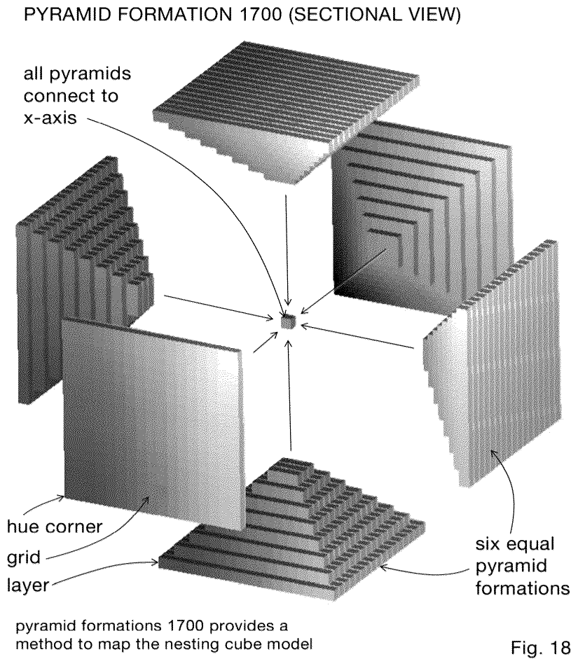

In accordance with an exemplary embodiment of the claimed invention, as shown in FIGS. 17 and 18, connecting the four (4) corners of any designated hue axis corner side to the center point (X-axis) of the claimed nesting cube model 800, creates a pyramid-like formation 1700. There are six (6) of these pyramid formations 1700 in total. In accordance with an exemplary embodiment of the claimed invention, these pyramid formations 1700 can also be created by connecting the eight (8) opposite corners (R>X<C, G>X<M, B>X<Y, K>X<W) of the claimed nesting cube model 800 to the center cube x-axis (X). As there is now a defined center point (X-axis), in accordance with an exemplary embodiment of the claimed invention, the formula (y+1+y) now extends to all eight corners. In a sense, the X-axis acts like a ninth corner, anchoring the entire nesting cube structure. In accordance with an exemplary embodiment of the claimed invention, the six (6) pyramid formations 1700 are identical in size and contain exactly the same number of individual cubes 810. The pyramids “tier” as each identical layer moves progressively closer, layer by layer, to the X-axis located in the center of the nesting cube. In accordance with an exemplary embodiment of the claimed invention, this tiered pyramid structure 1700, in tandem with the cross formation, provides a method by which to map the claimed nesting cube model 800. In accordance with an exemplary embodiment of the claimed invention, the grid of every side is mapped by longitude and latitude. The individual cubes 810 in the grid are equidistantly spaced, which advantageously produces a Cartesian mapping system. While the claimed zenColor Cross creates the claimed nesting cube model 800, the pyramid formation 1700 of the claimed invention provides a way to map the claimed nesting cube model 800.

### Data Mapping Color Language Code

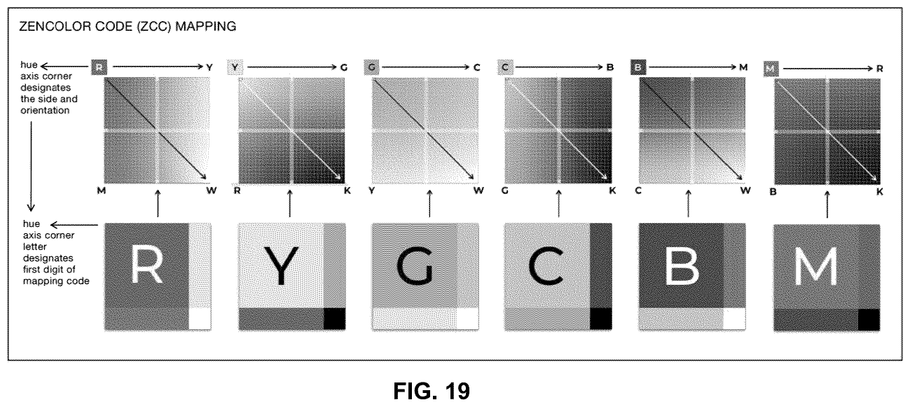

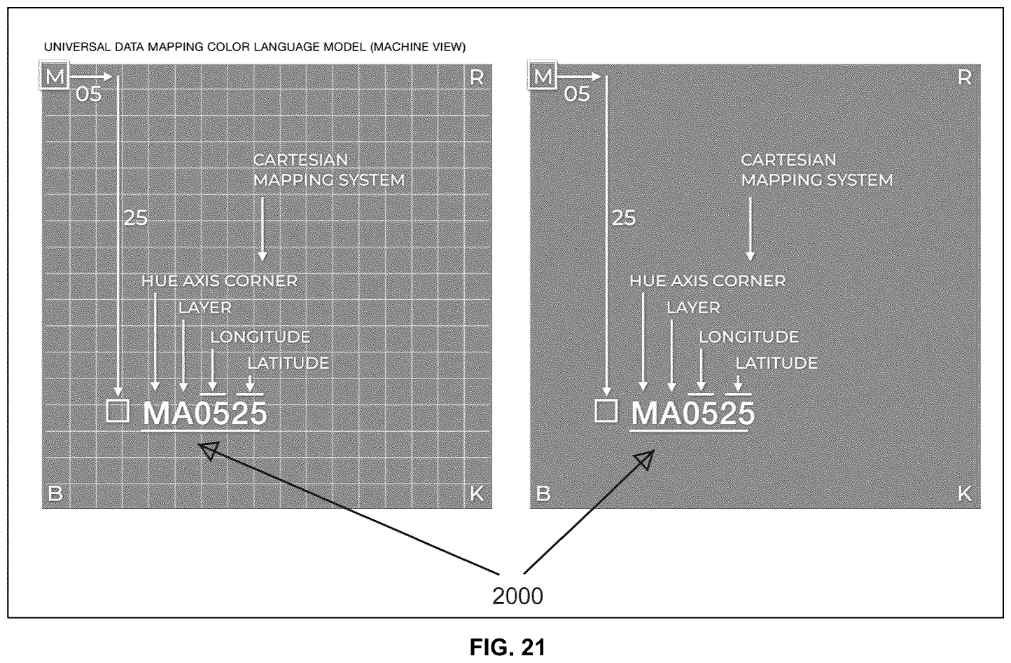

Turning now to FIGS. 19-21, in accordance with an exemplary embodiment of the claimed invention, the data mapping color language model is represented by a six-digit code. In accordance with an exemplary embodiment of the claimed invention, the six-digit code or the color code 2000 consists of the hue axis corner, as exemplary shown in FIG. 21, a grid displayed in longitude, latitude, and a layer. One example of the color code for data mapping color language mode is zenColor Code (ZCC®) 2000, ZCC® is a registered trademark of applicant (zenColor Global, LLC). The color code is a perfectly balanced and equidistant Cartesian mapping system. In accordance with an exemplary embodiment of the claimed invention, the longitude and latitude are mapped to each of the six sides of the nesting cube, the grid decreasing layer by layer to the center (x-axis). The order of the mapping code can be changed to denote different model formats, but the basic components that represent the code remain the same:
HUE SIDE AXIS: one digit (R, Y, G, C, B, M)
LONGITUDE: two digits (00)
LATITUDE: two digits (00)
LAYER: one digit (A, B, C, D, E, F, G, H, J, K, L, M, N, P, Q, R, X)
INDIVIDUAL CUBE CODE: 6 digits

For the purpose of identification, in accordance with an exemplary embodiment of the claimed invention, each individual cube 810 in the nesting cube format 800 requires an assigned mapping code. The color codes 2000 serve that purpose. In accordance with an exemplary embodiment of the claimed invention, the data mapping language provides an identifiable code 2000, along with the orientation of that code. While a machine cannot “see” color, it can understand orientation which is what the data mapping language model provides. Accordingly, the claimed invention advantageously enables a machine to measure and understand the position of any individual cube within the overall nesting cube format. As such, the color codes 2000 advantageously provide a means to map the nesting cube without color attributes.

The Hue Corners (Red, Yellow, Green, Cyan, Blue, and Magenta) define the sides of the cube. This provides a starting point by which to map each layer of the cube, as well as the orientation that is needed to teach the claimed mapping language to a machine.

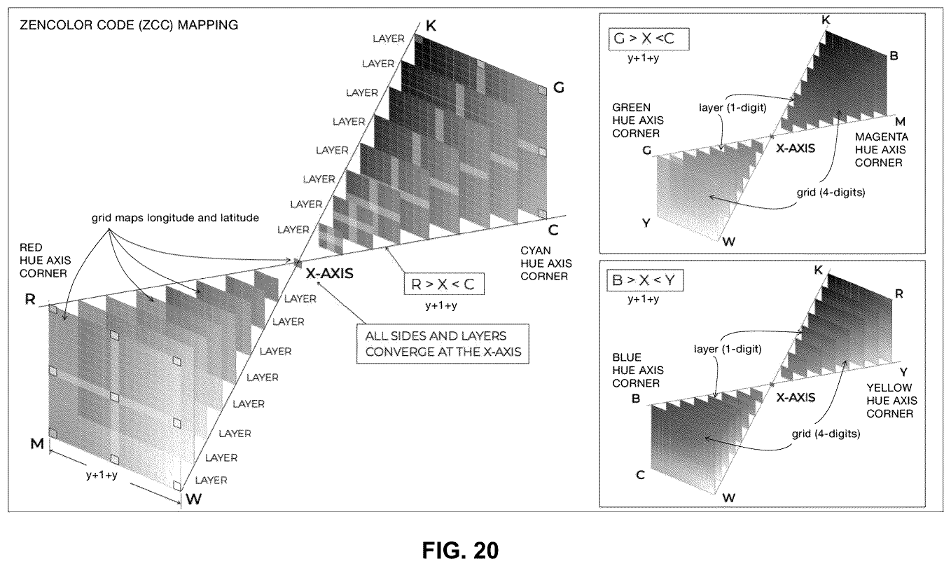

As exemplary shown in FIG. 20, the layers of the nesting cube 800 converge at the center point (X-Axis). The longitude and latitude are mapped to each of the six sides of the nesting cube, the grid decreasing layer by layer to the center (X-axis).

### Cube Color Attributes and Data Visualization

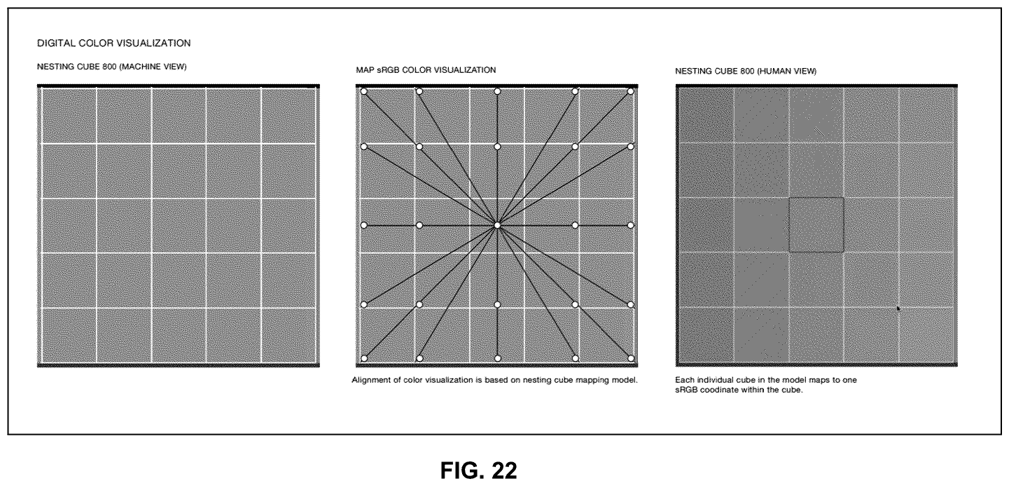

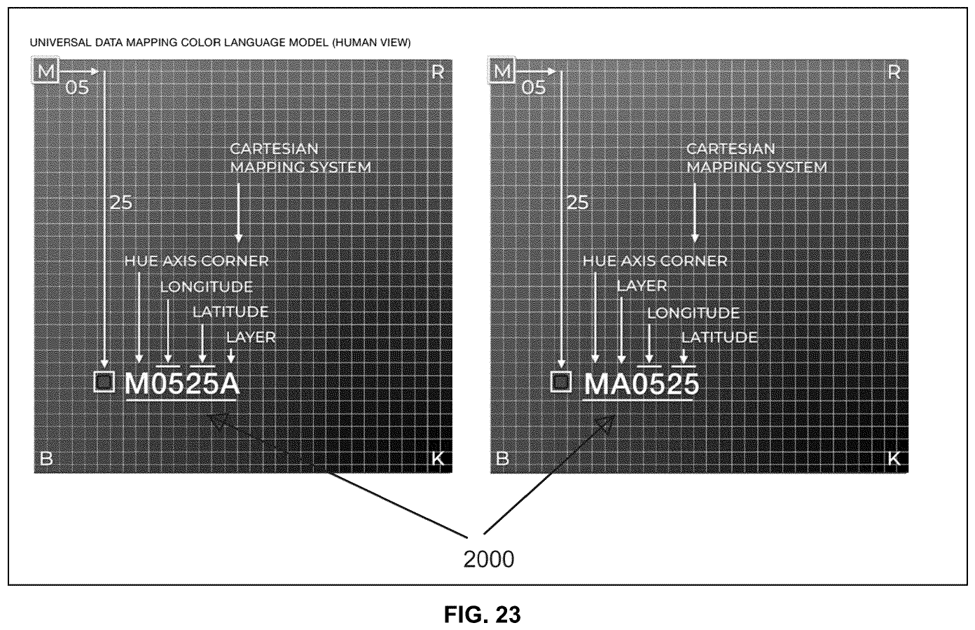

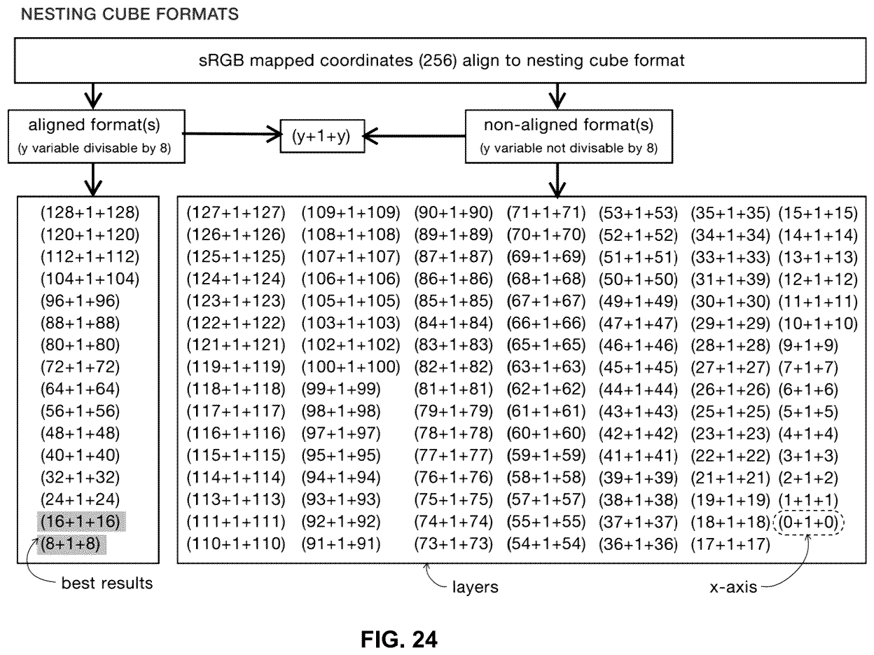

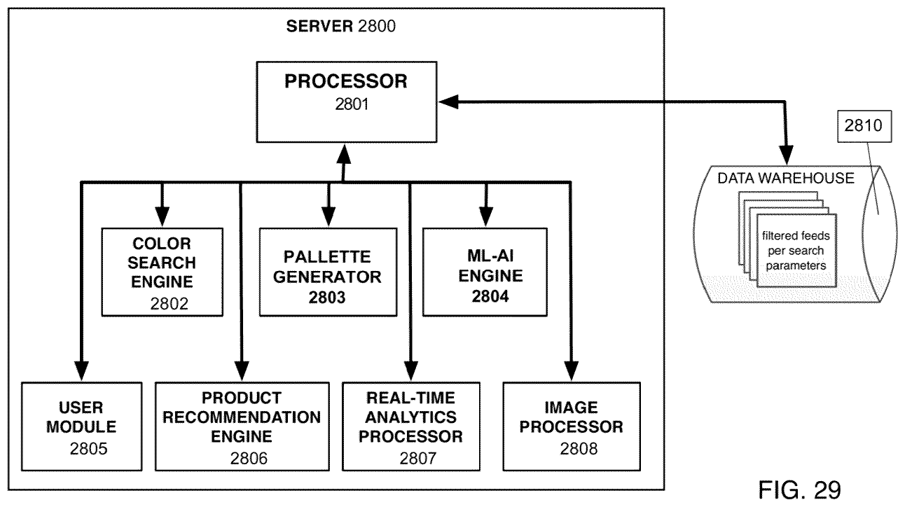

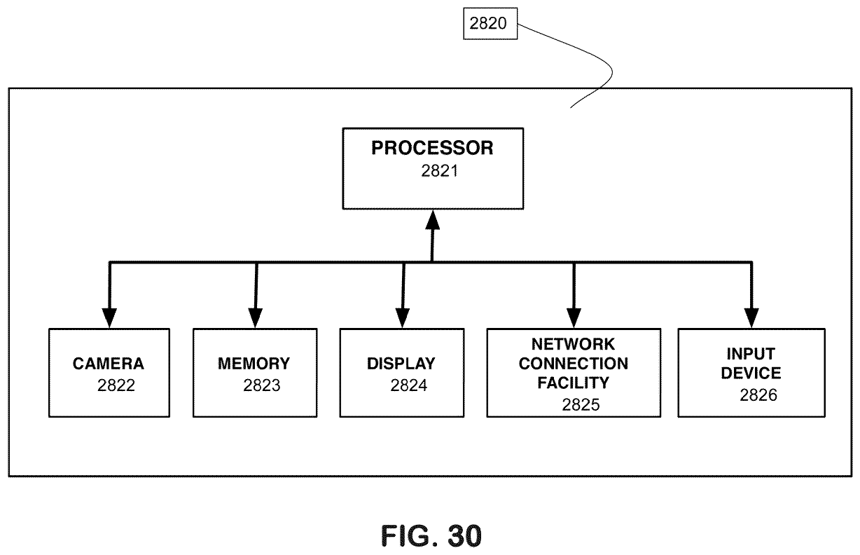

The data points ingested by machine learning and artificial intelligence (ML-AI) engine 2804 (FIG. 29) are critical to Artificial Intelligence. While a machine may not need to “see” a color, a human being does. For color data to be analyzed by Artificial Intelligence and then fed back to a human, a color attribute will need to be applied. This holds true for any interaction with a human being for any usage of the nesting cube color language model. The sRGB color space is not designed for this purpose. In accordance with an exemplary embodiment of the claimed invention, as shown in FIGS. 22 and 23, the alignment and merger of the two models advantageously provides a method to programmatically assign a color attribute to each individual cube. Adding the color attribute to the nesting cube format in either two- or three-dimensional format, provides a means by which the human eye can visualize the data. The claimed nesting color cube allows data visualization with the human eye, which enables a colorized nesting cube model 800 to be advantageously displayed on a digital substrate, i.e., digital device. The mapping is the same on every side and layer through the claimed nesting cube model 800.

Identifying a precise hue that is represented by a color cube code 2000, such as the zenColor Code (ZCC®), is not dependent on the human eye. The color cube code or the color code 2000 of the claimed invention does not rely on subjective words like “red” or “tequila sunrise” to describe a color. The claimed numeric color code 2000 is completely objective. Nor does it depend on a coordinate system that contains so much visual redundancy that it is impossible to differentiate one coordinate from another. Instead, in accordance with an exemplary embodiment of the claimed invention, these sRGB coordinates are merged into the nesting cube model 800 and identified with the claimed universal color data mapping language. Without the claimed universal language model, it would be impossible to collect and index color data by the machine learning and Artificial Intelligence engine 2804.

### Nesting Cube Formats

In accordance with an exemplary embodiment of the claimed invention, eliminating the gaps 390 and creating defined midpoints (+1) creates the basis for aligning and merging the color models. The nesting cubes 810, like the coordinates, are fixed in position. Without this similarity, it would be impossible to align and merge the models. The size and number of the sRGB color coordinates are also fixed. There will never be more or less than 256 coordinates from corner to corner, with 16,777,216 coordinates in total. In accordance with an exemplary embodiment of the claimed invention, the size and number of the individual nesting cubes, however, is a variable. This variable is defined by the format (y+1=y). The size and dimension of an individual cube is variable. In accordance with an exemplary embodiment of the claimed invention, the variable is based on the number of cubes contained in the “y” portion of the equation. For example, as shown in FIG. 24, if “y” equals 8, the format is represented as 8+1+8, that is sRGB cube is mapped to 8-bit channel. If y equals 16, the format is represented as 16+1+16, that is sRGB cube is mapped to 16-bit channel. In accordance with an exemplary embodiment of the claimed invention, the total number of individual cubes will always vary based on the “y” in the formula.

### Examples

$$8 + 1 + 8 = 17 ; 17 \times 17 \times 17 = 4 , 913 ( cubes )$$

$$16 + 1 + 16 = 33 ; 33 \times 33 \times 33 = 35 , 937 ( cubes )$$

Considering the sRGB color space is mapped to 8-bit channels, the nesting cube model 800 works best when mapped to a factor of eight. This produces a logical grid and a balance between the sides and layers that go from the outside of the nesting cube 800 to the x-axis.

All nesting cube formats are not created equal. Those that are not in the correct ratio fail to properly align with the sRGB color model. The best nesting cube formats that meet this criterion are actually the smallest.

As shown in FIG. 24, Format 33 (16+1+16) meets the formatting criteria. It has the right color range for product design and content coding. This makes it useful to capture and index the color data from both digital and non-digital mediums for machine learning and Artificial Intelligence.

Also, as shown in FIG. 24, Format 17 (8+1+8) also meets the criteria and, when used in tandem with Format 33, in accordance with an exemplary embodiment of the claimed invention, this language model provides a method to filter and bucket the data for search, data analytics, and data marketing.

### Color Visualization for Machines and Humans

No two humans see or describe color in the same way. This makes all color visualization that is dependent on the human eye both random and subjective. Machines, unlike humans, cannot “see” or describe color. As noted herein, to do so requires a mathematically based universal color data mapping language model that is both colorblind and completely objective. In accordance with an exemplary embodiment of the claimed invention, this is achieved by merging the data input from all digital and non-digital color mediums into a universal data mapping color language model that is teachable to a machine. An objective universal data mapping color language model is not dependent on subjective color descriptions or interpretive digital color numbering systems. The claimed nesting cube mode is teachable and objective. As it is not dependent on color visualization, it is readily applicable to machine learning and Artificial Intelligence engine 2804.

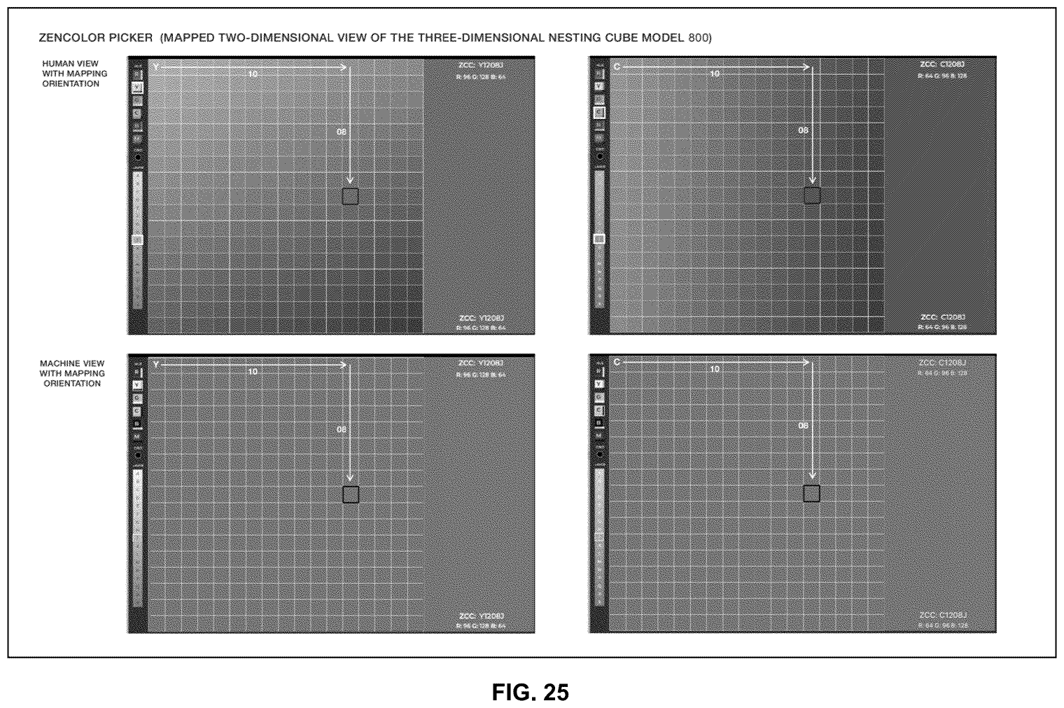

In accordance with an exemplary embodiment of the claimed invention, as shown in FIG. 25, the three-dimensional nesting cube 800, when flattened to or represented in a two-dimensional format with navigation, creates a mapping system color picker than can easily orient and locate precise color hues for machines and humans alike. Unlike, sRGB color pickers, the claimed nesting cube picker or zenColor nesting picker 2100 is able to properly display the entire RGB gamut of digital colors as an organized swatch library.

A machine cannot “see” color attributes. It is colorblind. A machine, however, does require orientation within a fixed space to determine color values. Design and merchandising teams, however, still rely on the human eye to select “pleasing” colors. While the claimed color language model was created for data mapping and machine learning, in accordance with an exemplary embodiment of the claimed invention, as shown in FIG. 25, it also can provide color visualization by mapping the individual cubes to RGB color values. This not only makes it possible to display color on a digital device, but it also allows an Artificial Intelligence program to provide human beings with color data visualization.

The color attributes assigned to the individual nesting cubes 810, like all other mediums, must be displayed in RGB to appear on a device. As shown in FIG. 25, the selection of the color attributes, however, will vary from each individual cube 810 to cube 810 based on the position mapping of the grid. That said, the mapping of the color attribute is logical and consistent throughout the nesting cube model 800 in accordance with an exemplary embodiment of the claimed invention. Although this logic is more useful to a machine than a human being, both benefit, albeit in different ways, from the assignment of color attributes to the data mapping language model.

### A Universal Color Data Mapping Language Model is the Best Method to Index Color Data for Machine Learning and Artificial Intelligence

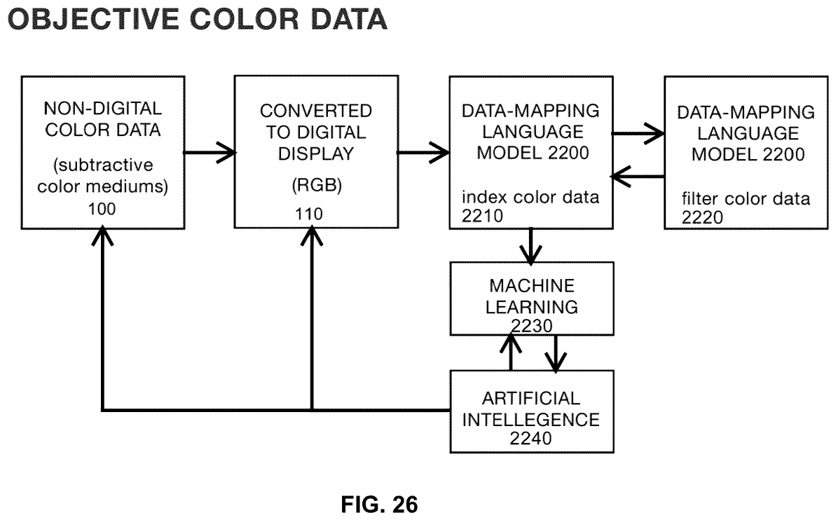

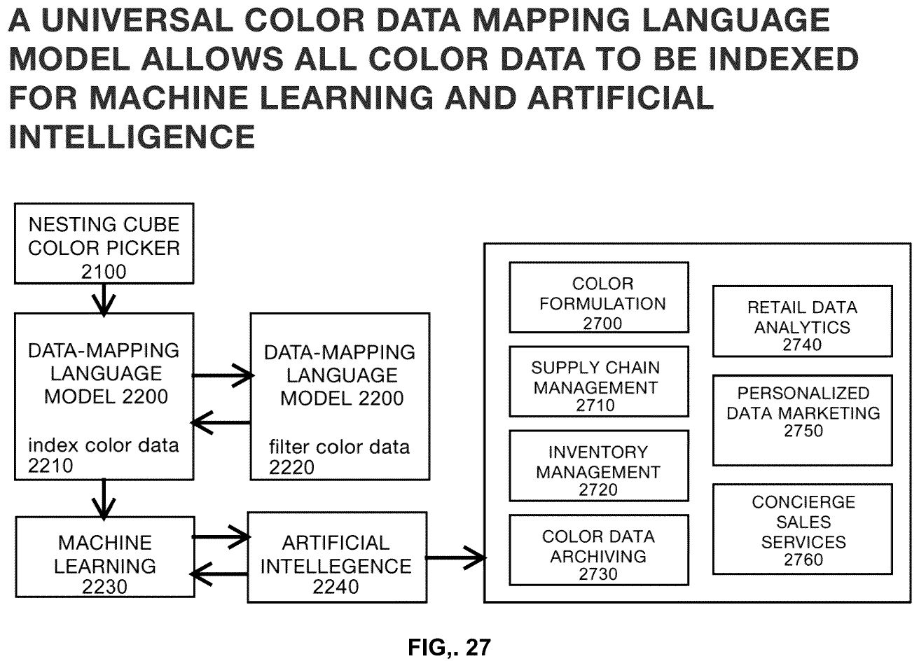

Turning now to FIGS. 26 and 27, the universal color data mapping language model is neither additive nor subtractive. In accordance with an exemplary embodiment of the claimed invention, the universal color data mapping language model 2200 is universal and can be applied to both digital and non-digital substrates (steps 100, 110). As such, the claimed universal color data mapping model 2200 is unique and useful. The claimed universal color language model 2200 provides retailers and manufacturers with a tool to identify, filter and index all other digital and non-digital color information at any point in the lifecycle of any product with a standardized color attribute (steps 2210, 2200). In accordance with an exemplary embodiment of the claimed invention, the claimed universal color language model 2200 collects, filters and indexes both digital and non-digital color data (steps 2210, 2220), both historic and trending, for deep machine learning (step 2230). These color data points can be ingested and interpreted further by Artificial Intelligence for a multitude of useful purposes (step 2240). It is appreciated that the claimed universal data mapping color language model 2200 can be applied to a wide variety of useful applications across all aspects of the product ecosystem that benefits both retailers, wholesalers, distributors, manufacturers and consumers. That is, the claimed color language model 2200 will benefit retailers and manufacturers in all areas of product development, eCommerce search, color formulation 2700, supply chain management 2710, inventory management 2720, color data archiving 2730, data analytics 2740, personalized data marketing 2750, and data visualization to provide concierge sales services 2760 to all consumers powered by machine learning and Artificial Intelligence engine.

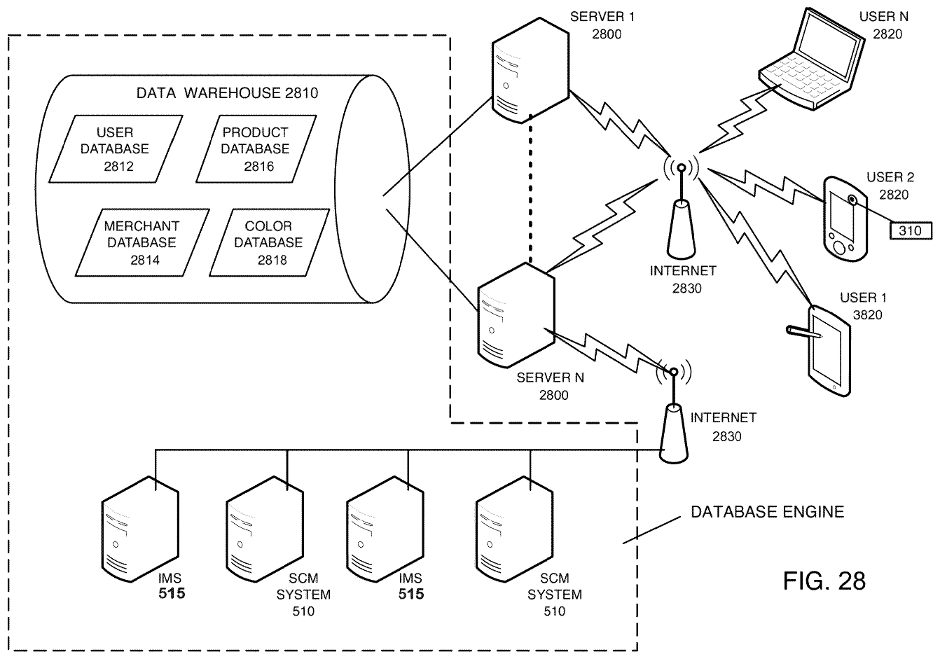

Turning to FIG. 28, in accordance with an exemplary embodiment of the claimed invention, there is shown an exemplary system configuration comprising a processor-based system, such as one or more processor-based computers or processor-based servers 2800, with the hard disk or memory drives running software comprising machine-readable program instructions. Server 2800 serves as and/or provides access to the data warehouse 2810, which comprises the product database 2816 and the color database 2818. Preferably, data warehouse 2810 also comprises user database 2812 and the merchant database 2814. All data are maintained in the data warehouse 2810 or other conventional database system having read and write accessibility using a database management system. Although described herein for illustrative purposes as being separate data stores, in at least some alternative embodiments, the data stores may be combined in various combinations.

Information contained in the data warehouse 2810 is accessible by both consumer and Merchant users via the client devices 2820 over a communications network 2830, such as the Internet 2830. Client devices 2820 comprise processor-based machine(s), such as laptops, PCs, tablets, smart phones and/or other web-enabled handheld devices to and from which the server 2800 communicates. In accordance with an exemplary embodiment of the claimed invention, as exemplary shown in FIG. 30, the client device 2820 comprises a processor 2821, an optional camera 2822, a memory 2823, a display 2824, a network connection facility 2825 and an input device 2826. The client devices 2820 are connected to the server 2800 utilizing customizable interfaces described herein. The custom interfaces may be in the form of a graphical user interface, an application to form a client-server arrangement and/or other well-known interface conventions known in the art. Depending on the nature of the user and its access to various forms of information, different interfaces are made available. To support various options, the system of the present invention preferably includes at least one application-programming interface (API) so that certain types of users could enhance their interfaces, and different ones may be available for users and Merchants.

In accordance with an exemplary embodiment of the claimed invention, the subscribers (consumer or Merchant users, etc.) gain entry to the server 2800 by subscription using known security methodologies, e.g., username and password combination. Once a subscriber is authenticated, the server 2800 provides access to the data that the subscriber can rightfully access.

As more fully described in applicant's normalization/codification application, the server 2800 receives product information (i.e., feeds) over the communications network 2830 from a plurality of Merchants. The server 2800 receives the feeds from retailers', wholesalers', and/or manufacturers' inventory management systems (“IMS”) 515 or supply chain management (“SCM”) systems 510. It is appreciated that for simplicity merchants, retailers, wholesalers and manufacturers will be collectively and interchangeably referred to herein as Merchants. Preferably, as new products are added or product information is updated in the IMS 515 and/or the SCM system 510, the corresponding information is transmitted to the server 2800. That is, the IMS 515 and/or SCM system 510 dynamically transmit the updated information to the server 2800.

SCM is the management of the flow of goods. It includes the movement and storage of raw materials, work-in-process inventory from inception to finished goods. SCM is defined as the design, planning, execution, control, and monitoring of supply chain activities with the objective of taking a product from inception (design) to a finished product. A product runs through the SCM system 510 and, when finished, transfers into the IMS 500 which tracks the finished goods.

The SCM system 510 is a production based system used by factories and their component suppliers. Within the SCM system 510 there may be an element of the IMS 500, which would be used to keep track of the inventory of components and raw materials. That said, the SCM system 510 is strictly a B2B (business-to-business) system that does not involve the consumer unless it is utilized for the use of “previewing” future inventory to a consumer in order to gauge future sales and make adjustments during the manufacturing process.

Whereas, the IMS 515 is a computer-based system for tracking inventory levels, orders, sales and deliveries. It can also be used in the manufacturing industry to create a work order, bill of materials and other production-related documents. Companies use the IMS 515 to avoid product overstock and outages. It is a tool for organizing inventory data that before was generally stored in hard-copy form or in spreadsheets.

Modern IMS 515 often rely upon barcodes and radio-frequency identification (RFID) tags to provide automatic identification of inventory objects. Inventory objects can include any kind of physical asset: merchandise, consumables, fixed assets, circulating tools, library books, or capital equipment. To record an inventory transaction, the IMS 515 uses a barcode scanner or RFID reader to automatically identify the inventory object, and then collects additional information from the operators via fixed terminals (workstations), or mobile computers.

The new trend in inventory management is to label inventory and assets with quick response (QR) Code, and use smartphones to keep track of inventory count and movement. These new IMS 515 are especially useful for field service operations, where an employee needs to record inventory transaction or look up inventory stock in the field, away from the computers and hand-held scanners.

The barcodes, RFID tags and QR codes are normally implemented during the production process as part of the Specification Sheet (Spec Sheet) which conveys all of the product details such as Color Code, Style Code, Vendor Code, and the information (fabric content, size, product category) that may be contained within any or all of these codes. The SCM system 510 stores the Spec Sheet. The barcodes, RFID tags and QR codes are also used as a tool to track inventory sales in the IMS 515 which is done by scanning at point of sale.

Without the universal digital data-mapping color language model of the claimed invention, color data from these various barcodes and tags cannot be identified or defined. If the color name is “sterling blue” and the actual color is a shade of blue grey, a search for the color will produce the tagged names unless the system is performing an image analysis for the precise color and ignoring the information provided by barcodes and tags. Once the color is normalized, codified and categorized into a single universal digital system of the claimed invention, the same search now can be performed more effectively by search based on color in the normalized, codified and categorized IMS 515 no matter what contextual color name is used to describe the product.

The claimed invention converts conventional SCM systems 510 and IMS 515 into an efficient color-based system that can be efficiently searched based on color and product categories. The claimed system normalizes, codifies and categorizes the data stored in the various SCM systems and IMS into colors based on the universal color code, and further categorizes the color normalized, codified and categorized data into product categories. Color is the only common denominator that all products have in common, the claimed invention provides a mechanism for searching based on the universal digital color code that is shared by the members of the supply chain management, including but not limited to merchants, manufacturers, distributors, retailers, component manufacturers, etc.

Since information relating to products provided by different Merchants is often expected to be formatted differently from one another, data received from various Merchants are transformed or normalized to a common format (e.g., an image of predetermined size, such as 500 pixels by 500 pixels), so that the information can be processed consistently and efficiently by the server 2800.

By utilizing the universal digital data-mapping color language model for a plurality of Merchants, the claimed invention resolves a significant hindrance to user searching for and finding products from different Merchants. Reverse mapping enables dynamic analysis and codification of precise color. When layered into proprietary Merchant IMS 515 and/or SCM systems 510, the search performed in accordance with an exemplary embodiment of the claimed invention is further enhanced as it is no longer requires scraping the Internet. Likewise, the claimed invention ameliorates issues associated with Merchant product planning and production by providing them with standardized color information on sales, searches and availability.

In accordance with an exemplary embodiment of the claimed invention, as shown in FIG. 29, the server 2800 comprises one or more processors 2801, a color search engine 2802, a palette generator 2803, a machine learning and artificial intelligence (ML-AI) engine 2804, a user module 2805, a product recommendation engine 2806, a real-time analytics processor 2807, and an image processor 2808. The server 2800 obtains data from a variety of sources. In accordance with an exemplary embodiment of the claimed invention, the color palette generator 2803 of the server 2800 generates color palette based on the user's personal and demographic information, such as, but not limited to, name, location, birth date, preferred products, and preferred colors, obtained from a user/subscriber (or a different user/subscriber) by the user module 2805 of the server 2800. The processor 2801 of the server 2800 obtains data regarding products and inventories from Merchants' IMS 515 as part of the IMS feeds and/or from Merchants' SCM systems 510 as part of the SCM feeds, and the data may be in the form of text, images, videos, or some combination thereof.

Each data set introduced in the data warehouse 2810 represents interrelated data sets that communicate with and rely on other data sets for complete information (but do not necessarily represent discrete data sets). These data sets may be accessed using a variety of database management systems (DBMS), including but not limited to relational database management systems (RDBMS) and “post-relational” database management systems (e.g., not only Structured Query Language (“NOSQL”) database management systems. Furthermore, by using a DBMS such as RDBMS or a “post-relational” DBMS, the data may be available to a Merchant in a variety of manners, such as based on a specific demographic profile or a specific color or color grouping.

In general, data are received from a variety of sources, with at least some or all data/content received using live feeds from sources. Results may be sent to a variety of destinations, all related to combinations of consumer preferences, Merchant inventory, recent activity, and transactions. The sources of data include stores, including their inventory on-hand in various stores and on order, other Merchants and their facilities, and portions of a store or Merchant's supply chain, such as manufacturers and designers of the goods sold by the stores/Merchants, and preferably, including live feeds from each. Data sources also include consumers and financial institutions, as well as other independent sources (such as but not limited to news, weather, and media feeds). At least some of the data are received or obtained in real time by the data warehouse 2810, preferably using live feeds. The real-time analytics processor 2807 can perform analysis on demand or even as the data is being received by the server 2800 and the data warehouse 2810. The real-time analytics processor 2807 delivers the results of the analysis in near real-time, even while the consumer is in the midst of shopping, such as delivering guidance to consumers as they shop based on recent inventory changes.

In accordance with an exemplary embodiment of the claimed invention, the processor-executable or computer-executable instructions may be stored on a non-transitory computer-readable medium, such as a CD, DVD, flash memory, or the like. The processor-executable or computer-executable instructions may also be stored as a set of downloadable processor-executable or computer-executable instructions, for example, or downloading and installing from an Internet location (e.g., Web server).

The accompanying description and drawings only illustrate several embodiments of a system, methods and interfaces for color-based identification, searching and matching, however, other forms and embodiments are possible. Accordingly, the description and drawings are not intended to be limiting in that regard. Thus, although the description above and accompanying drawings contain much specificity, the details provided should not be construed as limiting the scope of the embodiments but merely as providing illustrations of some of the presently preferred embodiments. The drawings and the description are not to be taken as restrictive on the scope of the embodiments and are understood as broad and general teachings in accordance with the present invention. While the present embodiments of the invention have been described using specific terms, such description is for present illustrative purposes only, and it is to be understood that modifications and variations to such embodiments may be practiced by those of ordinary skill in the art without departing from the spirit and scope of the invention.

1. A computer-implemented method for homogenizing a RGB (red, green, blue) digital color cube into a smaller and usable subset, comprising:
merging fixed coordinates of the RGB digital color space into a color cube, mapped to distinct hue corner sides and layers that get progressively smaller until sides of the color cube converge in a center point of a three-dimensional nesting cube model to form a merged three-dimensional color nesting cube comprising a plurality of individual nesting cubes;
consolidating duplicate colors in the RGB digital color space that are not distinguishable to a human eye to obtain a smaller and usable digital color space; and
organizing the smaller and usable digital color space into equidistant color buckets to provide an orientation throughout the merged three-dimensional color nesting cube, each cube of the merged three-dimensional nesting cube representing a unique color mapping code of a universal digital data-mapping color language model.

2. The method of claim 1, wherein the merged three-dimensional color nesting cube comprises following six hue axis corners: a red side with a red hue axis corner, a yellow side with a yellow hue axis corner, a green side with a green hue axis corner, a cyan side with a cyan hue axis corner, a blue side with a blue hue axis corner, and a magneto side with a magneto hue axis corner.

3. The method of claim 2, further comprising flattening the merged three-dimensional color nesting cube into connecting two-dimensional sides, each two-dimensional side forming a grid mapping the merged three-dimensional color nesting cube to a hue axis corner, a longitude representing a horizontal movement within the grid, a latitude representing a vertical movement within the grid and a distinct layer that connects the two-dimensional sides, getting progressively smaller until the two-dimensional sides converge in the center point of the merged three-dimensional color nesting cube.

4. The method of claim 3, wherein the unique color mapping code is defined by the grid mapping to the hue axis corner, the longitude, the latitude and the distinct layer.

5. The method of claim 4, further comprising generating a digital color attribute from the unique color mapping code for each individual nesting cube in a model format to enable data visualization by a human eye.

6. The method of claim 5, further comprising assigning the unique color mapping code of the universal digital data-mapping color language model to a product that is closest to an individual nesting cube of the merged three-dimensional color nesting cube based on color component intensity values for at least one dominant color of the product.

7. The method of claim 6, further comprising attaching digital and non-digital metadata to the unique color mapping code to a digital image of the product and uploading the digital image embedded with the digital and non-digital metadata to an eCommerce platform.

8. The method of claim 7, further comprising homogenizing color data across the eCommerce platform to provide a homogenized eCommerce platform by: matching a digital image of each product offered in the eCommerce platform to one of a plurality unique color mapping codes of the universal digital data-mapping color language model; embedding the digital and non-digital metadata to the digital image of said each product; and uploading the digital image of said each product embedded with the digital and non-digital metadata to the eCommerce platform.

9. The method of claim 8, further comprising displaying a graphical user interface with a normalized color palette of the universal digital data-mapping color language model to an online shopper on the homogenized eCommerce platform so that the online shopper can search for a desired product by the normalized color palette of the universal digital data-mapping color language model.

10. The method of claim 9, wherein the plurality of unique color mapping codes of the universal digital data-mapping color language model is indexed; and further comprising ingesting indexed plurality of unique color mapping codes by a machine learning and artificial intelligence engine to color coordinate products on the homogenized eCommerce platform; and generating personalized color coordinated product suggestions based on a unique color mapping code of the desired product.

11. The method of claim 10, further comprising generating retail data analytics and personalized data marketing to online shoppers based on search results and shopping history on an eCommerce platform by the machine learning and artificial intelligence engine.

12. A machine learning based mapping system to color coordinate products, patterns and objects on a homogenized eCommerce platform implementing the computer-implemented method of claim 1 for homogenizing the RGB digital color space into the universal digital data-mapping color language model, comprising:
a plurality of processor-based client devices, each client device being uniquely associated with an online shopper;
a database engine comprising a plurality of products available on the homogenized eCommerce platform; and
a processor-based server of the eCommerce platform connected to a communication system to:
receive search queries from a plurality of client devices;
search the database engine for products matching the search queries; and
display the products matching the search queries and color coordinated product suggestions generated based on the search queries.
